(19) United States
(12) Patent Application Publication
(10) Pub. No.: US 2008/0221994 A1
(43) Pub. Date: Sep. 11, 2008

(54) MULTI-LEVEL MARKETING SYSTEM

(76) Inventors: David A. Rutz, Highland, MI (US); Daryl V. Turner, Scottsdale, AZ (US)

Correspondence Address: SCHMEISER OLSEN & WATTS, 18 E UNIVERSITY DRIVE, SUITE # 101, MESA, AZ, 85201, US

(21) Appl. No.: 12/044,786

(22) Filed: Mar. 7, 2008

Related U.S. Application Data
(60) Provisional application No. 60/906,135, filed on Mar. 8, 2007.

(51) Int. Cl. G06Q 30/00

(52) U.S. Cl. 705/14

(57) ABSTRACT

A multi-level marketing system includes a holding company and a multi-level marketing company operated by the holding company, wherein the multi-level marketing company provides a product and/or service. A distributor buys the product and/or service from the multi-level marketing company, and one or more individuals purchase the product and/or service from one of the distributors.

### CROSS-REFERENCE TO RELATED APPLICATIONS

This application claims priority to U.S. Provisional Application No. 60/906,135, entitled “METHOD AND SYSTEM OF A PARADIGM SHIFT FOR MULTI-LEVEL MARKETING”, which was filed on Mar. 8, 2007, the contents of which are incorporated herein by reference.

### BACKGROUND OF THE INVENTION

1. Field of the Invention

This invention relates to multi-level marketing systems which reduce risk for a company and provide incentives for its salespeople.

2. Description of the Related Art

Multi-level marketing (MLM) is often used by companies to sell products and/or services to consumers. In a typical situation, multi-level marketing employs a business distribution model which allows a company to market their products and/or services to consumers by using referrals and direct selling. Individuals are compensated based on their sales of a product and/or service, as well as the sales achieved by those they bring into their organization within the business. More information regarding multi-level marketing can be found in U.S. Patent Application No. 20060235749.

Individuals of a multi-level marketing system are often referred to as distributors, field representatives, salespeople, etc., and are rewarded a commission relative to the volume of products and/or services sold through each of their independent businesses. It should be noted that an individual can be characterized in many different ways. For example, an individual can be a single person or multiple people. Further, an individual can be a single entity, such as a business, or multiple businesses. Individuals develop their organizations by either building an active customer base, who buy directly from the parent company and/or by recruiting a down-line of independent distributors who also build a customer base, which expands the overall organization. Further, distributors can also earn a profit by selling products and/or services which they purchased from the parent company at a wholesale price.

Distributors earn a commission based on the sales efforts of their organization, which includes their independent sales efforts as well as the leveraged sales efforts of their down-line. This arrangement is similar to franchise arrangements in which royalties are paid from the sales of individual franchise operations to the franchiser as well as to an area or region manager. Commissions are paid to multi-level marketing distributors according to the company's compensation plan. There can be multiple levels of people receiving royalties or commissions from one person's sales.

In today's Internet economy, there is less need for the traditional multi-level marketing company or the overpriced products it sells. Hence, the new challenge for today's multi-level marketing companies is to offer both products and/or services at far more attractive pricing levels. With the growth of the Internet, the “distribution distance” between the consumers and manufacturers of products has been drastically reduced.

In some instances, consumers can purchase directly from the manufacturer at a more competitive price. Hence, the need for distribution “systems” is no longer as important as it once was. The new goal of the multi-level marketing company is no longer as focused on the products they sell, which may be available somewhere else to the public at the same or lower prices. Instead, the greater focus of the multi-level marketing company is in creating an “income opportunity” for the individuals of the multi-level marketing system. The multi-level marketing company can focus more on recruiting individuals into a business opportunity in which they can have an opportunity to earn more money.

The focus for the multi-level marketing system then becomes finding ways to compensate the individuals with more money as an enticement to join the multi-level marketing system. As a result, the products become over inflated, with the purpose of fueling and providing extra money to pay to the business builders “up the chain” (i.e. up-line) above the representative in the multi-level structure. For example, a $7.21 bottle of “wrinkle cream” can be marked up by the multi-Level marketing company and sold to the individual at “wholesale” for $46.99. The idea is that the individual of the multi-level marketing system will recruit additional individuals to join the multi-level marketing system, wherein the new individuals will buy into the program themselves and purchase the overpriced products so that everyone can earn money on the purchases of those individuals below them (i.e. the down-line).

In today's Internet economy, there is simply less need for the traditional multi-level marketing company or the overpriced products they sell. Thus, a new model for the multi-level industry is needed that is more consumer friendly and in tune with today's Internet economy and retail market place.

Traditional companies that sell products in today's market choose to be either product orientated, wherein they focus on selling products through a retail location with high profit margins and markup on high profits, or they are service orientated, wherein they focus on selling attractive products or services with low margins and focus on continual or repeat buying habits of their customers.

The new challenge for multi-level marketing companies is to offer products and/or services at far more attractive pricing levels. In fact, even the old power retailers, companies, such as Sears Roebuck, Woolworth's, Montgomery Ward, have either closed their doors, or have had to reinvent themselves to cater to the changing marketplace, while companies, such as Wal-Mart, have aggressively acquired new market share.

### BRIEF SUMMARY OF THE INVENTION

The present invention employs a method of operating a multi-level marketing company, which includes providing an individual a membership to the company in response to the individual paying a membership fee to the company, and allowing the individual to purchase a product and/or service from the company at a member price. The method includes providing the product and/or service to a consumer at a consumer price, wherein the consumer price is greater than the member price.

In some embodiments, the step of allowing the individual to purchase the product and/or service at the member price occurs after the individual has paid the membership fee. In some embodiments, the member price decreases as the membership fee increases. The step of providing a membership for the individual can include providing first and second membership levels, wherein the membership fee for the first membership level is greater than the membership fee for the second membership level. The individual purchases the product and/or service at first and second member prices at the first and second membership levels, respectively, wherein the first member price is less than the second member price.

The present invention provides a multi-level marketing system, which includes a manufacturer and a multi-level marketing company which buys at least one of a product and/or service from the manufacturer. The multi-level marketing system includes a plurality of distributors which buy at least one of the product and/or service from the multi-level marketing company, and one or more individuals which purchase at least one of the products and/or services from one of the distributors.

In some embodiments, the individual(s) is a member of the multi-level marketing company. The individual(s) can purchase the product and/or service at a member price after the individual has paid a membership fee to the multi-level marketing company. In some embodiments, the membership of the multi-level marketing company has a plurality of membership levels, wherein the membership fee for each membership level is different from the membership fee for another membership level. Further, the member price for each membership level is different from the member prices for another membership level. In general, the member price decreases as the member price increases.

The present invention provides a multi-level marketing system, which includes a holding company and a first multi-level marketing company operated by the holding company, wherein the first multi-level marketing company provides at least one of a product and/or service. The multi-level marketing system includes at least one distributor which buys at least one of the products and/or service from the first multi-level marketing company and one or more first individuals which purchase at least one of the products and/or services from one of the distributors of the first multi-level marketing company.

In some embodiments, the first individual(s) are members of the first multi-level marketing company. The membership of the first multi-level marketing company can have a plurality of membership levels. The first individual(s) can purchase a product or service at a member price from the distributor of the first multi-level marketing company.

In some embodiments, the multi-level marketing system further includes a second multi-level marketing company operated by the holding company, wherein the second multi-level marketing company provides at least one of the products and/or services. The multi-level marketing system includes at least one distributor which buys at least one of the products and/or services from the second multi-level marketing company and one or more second individuals which purchase at least one of the products and/or services from one of the distributors of the second multi-level marketing company.

In some embodiments, the second individual(s) are members of the second multi-level marketing company. The membership of the second multi-level marketing company can have a plurality of membership levels. The second individual(s) can purchase a product or service at a member price from the distributor of the second multi-level marketing company.

Further features and advantages of the invention will be apparent to those skilled in the art from the following detailed description, taken together with the accompanying drawings.

### BRIEF DESCRIPTION OF THE DRAWINGS

FIG. 1 is a flow diagram of a method of operating a multi-level marketing company, in accordance with the invention.

FIG. 2 is a flow diagram of another embodiment of the method of FIG. 1, in accordance with the invention.

FIG. 3 is a flow diagram of a method of operating a multi-level marketing company, in accordance with the invention.

FIG. 4 is a block diagram of a multi-level marketing system, in accordance with the invention.

FIGS. 5a, 5b and 5c are flow diagrams of commission structures, in accordance with the invention.

FIGS. 6a, 6b and 6c are flow diagrams of multi-level marketing systems, in accordance with the invention.

### DETAILED DESCRIPTION OF THE INVENTION

The subject of this invention is a new paradigm for multi-level marketing using the same multi-level marketing sales force, but getting the products or services to the end consumer at a much lower price. For example, a $7.21 bottle of “wrinkle cream” is made available to an individual for $13.99, instead of at a much higher price, such as $46.99, as in the current method of practice of most multi-level marketing companies. The invention enables a multi-level marketing company to substantially lower their mark-up price and, as a result, pass on the monetary savings to the end consumer. The invention follows the philosophy that low priced products sell themselves. Further, the invention allows a manufacturer or supplier to spend more money creating higher quality products or services while not being overly concerned with high mark-ups that may price the manufacturer or supplier's products or services out of the marketplace. As mentioned above, individuals of a multi-level marketing system are often referred to as distributors, field representatives, salespeople, etc.

In general, the new method and system of this invention, includes three components. The first component of the invention is the acceptance by the individual of a wholesale membership to the multi-level marketing company. The membership in the multi-level marketing company may be free or paid in a multiple of period payments or on an annual basis. This feature is similar to the membership fees paid to Sam's Club or Costco, or other wholesale stores that allow you to purchase merchandise at their locations for your own use or for selling to an end consumer.

The second component of the invention allows the individual, with a membership to the multi-level marketing company, to purchase a product or service at a substantially lower price, which allows the individual to sell the product at a more competitive price to the end consumer. The preferred pricing received by members also allows the individual to earn a substantially higher profit margin on the products and/or services they are selling. By being able to sell products at more competitive prices, and yet earning a far higher commission, the quality of the income opportunity provided to individual is also drastically enhanced. Further, a percentage of the purchase price paid to the multi-level marketing company may be paid out as a commission to the individual and the individual's up-line distributors.

The third component of the invention operates under the economic laws of supply and demand, wherein with products or services at lower prices, the multi-level marketing company is able to increase its volumes and allow for economies of scale that lower the manufacturing price of the product or service. Lowering the manufacturing price can allow the profit for the multi-level marketing company to increase, or it can allow the price the product and/or service is sold to the individual to decrease. If the product and/or service is sold to the individual at a lower price, the individual can make a higher mark-up or commission on the product and/or service being sold. If the product is sold to the individual at a lower price, the product and/or service can be sold to the end consumer at a lower price, which generally increases the volume of sales and, under the laws of supply and demand, generally increases the volume of sales. It should be noted that any of the three components discussed above can be implemented on-line, such as with the Internet or any other computer network.

In one embodiment of the invention, the member price to the multi-level marketing company allows the individual to purchase a product and/or service from the multi-level marketing company at an even lower price if the individual elects a preferred membership, such as silver, gold or platinum. Further, the preferred member price can allow the individual to obtain a rebate on their purchases. For example, if the individual achieves $X in volume sales (i.e. $1000) in a specified time period (i.e. 90 days), the individual will receive Y % (i.e. 2%) on the sale. If the individual achieves $XX (i.e. $10,000) in volume sales in a specified time period (i.e. 90 days), the individual will receive YY % (i.e. 3%) on the sales, which can result in larger commissions and an improved income opportunity because $XX is larger than $X and YY % is larger than Y %.

In one embodiment of the invention, a statistical model is used by the multi-level marketing company to pay the individual. In one example of the statistical model, a service contract is assigned a present value and a future value. The present and future values can be determined in many different ways, such as by the statistical average of time that a person in a specified category stays with that type of service contract, as well as the statistical average amount of money paid over the life of the service contract. In this embodiment, the customer selects the service contract from a individual, wherein the multi-level marketing company is allowed to make a higher one-time payment to the individual instead of multiple smaller payments over a period of time. This embodiment allows the multi-level marketing company to pay a one-time payment up through the individual's up-line distributors, rather than a larger number of smaller payments. The one-time payment is typically based on the net present value and the multiple smaller payments over time are typically based on the future value.

In one embodiment of the invention, the multi-level marketing company provides lower mark-ups, which allows the volume of sales to impact the quality of the products and/or services provided. Manufacturers can invest more into research and development, and in the ingredients or components of a specific product or service, without being overly concerned with the “after markup” price being too high for consumer acceptance. With the old model, manufacturers typically have to consider the high end price due to the large mark-ups that have to be added to cover distribution costs or commissions into the development costs.

The services and products sold through the inventive multi-level marketing company typically cannot be sold through a traditional multi-level marketing company because the margins are too low. Hence, the inventive multi-level marketing company can sell an IPOD, laptop computer or another type of consumer electronics, with only 5% markup, for example, because the multi-level marketing company does not need to keep as much income on the sale of products because of the membership fee. This allows the multi-level marketing company to add products or services that are not sold in the multi-level marketing industry today, and also provides for a better business opportunity.

In one embodiment of the invention, the distributor can “spin-off” another multi-level marketing company. For example, the multi-level marketing system can allow a distributor to spin off another multi-level marketing company in response to the distributor reaching a predetermined goal. In one example, the predetermined goal is for the distributor to sell a certain number of products. In another example, the goal is for the distributor to sell certain monetary value of products. In one example, the predetermined goal is for the distributor to have a down-line of a certain number of individuals.

The spun-off company can be formed in many different ways, such as a joint venture company. In some examples, the joint venture company can include the spun-off company, as well as the multi-level marketing company. In another example, the joint venture company can include the spun-off company, the multi-level marketing company, as well as the supplier. Ownership of the spun-off company can be split into separate shares, wherein the individual can control a certain number of shares. The shares of the spun-off company can also be offered to the public, if desired, in an initial public offering, direct public offering, or any other security offerings.

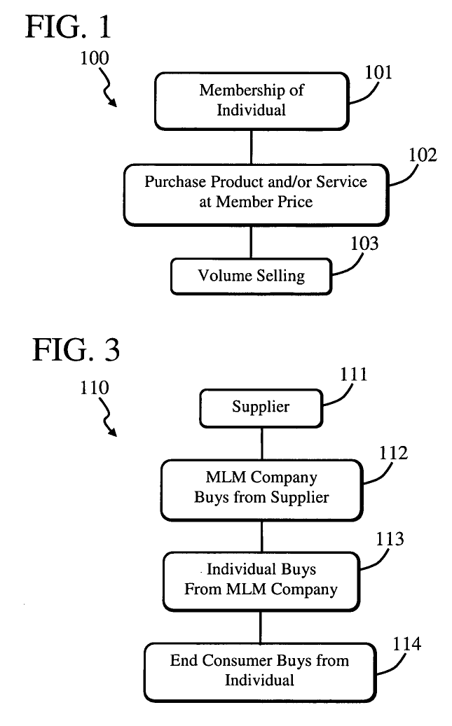

FIG. 1 is a flow diagram of a method 100 of operating a multi-level marketing company, in accordance with the invention. In this embodiment, method 100 includes a step 101 of a individual becoming a member of the multi-level marketing company. One way the individual can become a member of the multi-level marketing company is by paying a membership fee. The membership fee can be paid in many different ways, such as annularly, monthly, etc. The membership fee received by the multi-level marketing company reduces the risk of the company, as will be discussed in more detail below.

In this embodiment, method 100 includes a step 102 of purchasing a product and/or service from the multi-level marketing company by the individual at a member price. The risk of the multi-level marketing company is that associated with it purchasing the product and/or service, but then not being able to sell it. The risk for the multi-level marketing company is transferred to the individual in response to the individual paying the membership fee in step 101, because the membership fee partially offsets the cost of the company to purchase the product and provide the service.

The incentive for the individual to pay the membership fee is the opportunity to purchase the product and/or service from the company at the member price. The member price is determined by the company so that the individual will be able to sell the product and/or service at a consumer price, wherein the consumer price is greater than the member price. The member price paid for the product and/or service in step 102 is typically chosen so that the product and/or service can be purchased at a competitive price relative to the availability of the product and/or service through other companies. The consumer price is typically less than what a consumer pays for the product and/or service elsewhere. The difference between the consumer price and the member price is the mark-up, which corresponds to the profit. As the profit increases, there is more incentive for the individual to sell the product and/or service and, as the profit decreases, there is less incentive for the individual to sell the product and/or service.

This allows the individual to sell the product and/or service at the member price plus a first mark-up, wherein the member price and first mark-up is less than what it costs to purchase the product and/or service elsewhere at a consumer price. In this way, the risk of the company is reduced because the company receives money, in the form of the membership fee, before the product and/or service is sold. The risk is transferred to the individual who must sell the product and/or service to recoup the membership fee he or she paid to the company.

In this embodiment, multi-level marketing company 100 includes a step 103 of the individual selling the product and/or service in volume. The consumer price is chosen so that the individual can sell a larger number (i.e. large volume) of the product and/or service. As the consumer price decreases, the volume of sales increases and, as the consumer price increases, the volume of sales decreases. In this way, the individual relies on volume selling to sell the product and/or service and make a profit.

The member price paid by members allows the individual to make a substantially higher profit margin on the products and/or services they are selling. By being able to sell products and/or services at more competitive prices, and earning a far higher commission, the quality of the income opportunity provided to the individual is drastically enhanced. In addition, a percentage of the purchase price paid to the multi-level marketing company may be paid out to the individual, and the individual's up-line distributors. The percentage of the purchase price can be paid out to the individual, and the individual's up-line distributors, in many different ways, such as with a commission. It should be noted that method 100, as well as the other methods disclosed herein, can be implemented on-line, such as with the Internet or any other computer network.

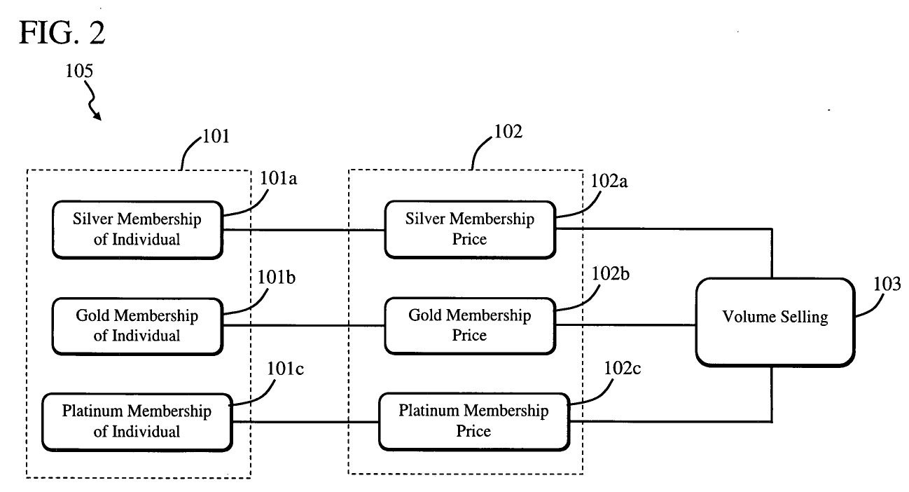

FIG. 2 is a flow diagram of another embodiment of method 100 of FIG. 1, wherein the method of FIG. 2 is denoted as method 105. In this embodiment, step 101 can include a step 101a of the individual becoming a silver member, a step 101b of the individual becoming a gold member and a step 101c of the individual becoming a platinum member. In this embodiment, the membership fee for the individual to become a silver, gold or platinum member is different. For example, the individual pays a higher membership fee to become a gold member than a silver member. Further, the individual pays a higher membership fee to become a platinum member than a gold member.

In this embodiment, step 102 can include a step 102a of the individual purchasing the product at the silver member price, a step 102b of the individual purchasing the product at the gold member price and a step 102c of the individual purchasing the product at the platinum member price. In this embodiment, the price for the individual to purchase the product at the silver, gold and platinum prices is different. For example, the individual pays a higher purchase price to purchase the product at the silver member price than the gold member price. Further, the individual pays a higher purchase price to purchase the product at the gold member price than the platinum member price.

By allowing the individual to choose his or her membership level, the individual can choose to purchase the product at different pricing levels. If the individual can purchase the product at a lower pricing level, then the individual can sell the product at a reduced mark-up and still make a profit. The multi-level marketing company still operates at a reduced risk because the company is receiving the membership fee from the silver, gold and platinum membership salespeople. The risk is less for the multi-level marketing company when the individual pays the platinum membership fee compared to the gold and silver membership fees because the platinum membership fee is more, so that the multi-level marketing company receives more money up-front. The risk is less for the multi-level marketing company when the individual pays the gold membership fee compared to the silver membership fee because the gold membership fee costs more, so that the multi-level marketing company receives more money up-front.

Method 105 includes step 103 of volume selling. The salespeople who are platinum members can sell the product at a reduced mark-up and still make the same profit because, as mentioned above, they are able to purchase the product from the multi-level marketing company at a lower price compared to gold and silver members. The salespeople who are gold members can sell the product at a reduced mark-up and still make the same profit because, as mentioned above, they are able to purchase the product from the multi-level marketing company at a lower price compared to silver members.

FIG. 3 is a flow diagram of a method 110 of operating a multi-level marketing company, in accordance with the invention. It should be noted that method 110, as well as the other methods of operating a multi-level marketing company disclosed herein, can be implemented on-line, such as with the Internet or any other computer network. In this embodiment, method 110 includes a step 111 of providing a supplier which provides a product, and a step 112 of providing a multi-level marketing company which purchases the product from the supplier.

Method 110 includes a step 113 of a individual purchasing the product from the multi-level marketing company. The individual is a member of the multi-level marketing company and can purchase the product at the member price. In some embodiments, the individual becomes the member of multi-level marketing company by paying a membership fee.

Method 110 includes a step 114 of an end consumer buying the product from the individual at a marked-up price, wherein the member price and marked-up price are a consumer price. The consumer price is typically less than what a consumer pays for the product elsewhere. The marked-up price is generally chosen so that the individual can offer the product at a competitive price. The marked-up price is chosen so that the individual can sell a larger number of the product. Hence, the individual relies on volume selling to sell the product.

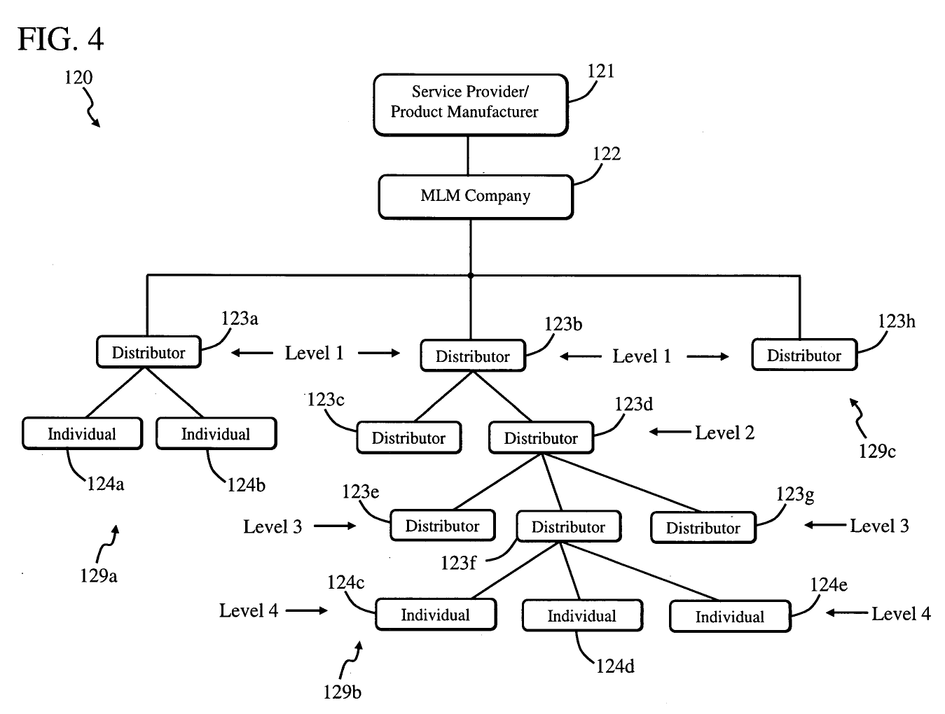

FIG. 4 is a block diagram of a multi-level marketing system 120, in accordance with the invention. It should be noted that system 120, as well as the other multi-level marketing systems disclosed herein, can include the Internet or any other computer network. Multi-level marketing system 120 is typically referred to as a binary, elevator or matrix, or network, multi-level marketing system. In this embodiment, multi-level marketing system 120 includes a service provider/product manufacturer 121, which provides a product and/or service.

In this embodiment, multi-level marketing system 120 includes a multi-level marketing company 122 which purchases the service or product from service provider/product manufacturer 121. It should be noted that multi-level marketing system 120 includes a number of branches that purchase the product or service from multi-level marketing company 122. In this embodiment, multi-level marketing system 120 includes three branches, which are denoted as branches 129a, 129b and 129c.

In this embodiment, each branch of multi-level marketing system 120 includes one or more distributors, several of which are denoted as distributors 123a, 123b and 123c. Distributors 123a, 123b and 123c are included in branches 129a, 129b and 129c, respectively. Hence, distributors 123a, 123b and 123c purchase the service or product from multi-level marketing company 122 at a member price. Further, each branch of multi-level marketing system 120 includes one or more levels, which are denoted as level 1, level 2, level 3 and level 4, wherein distributors 123a, 123b and 123h are included in level 1

In this embodiment, multi-level marketing system 120 includes a number of salespeople, which can be in the same or different branches, as well as in the same or different levels. For example, salespeople 124a and 124b are included in branch 129a and level 2, and purchase any products or services from distributor 123a. Hence, salespeople 124a and 124b are “down-line” from distributor 123a in branch 129a because they are in a different level. Further, distributor 123a is “up-line” from salespeople 124a and 124b. Salespeople 124a and 124b sell the product to the consumer at the consumer price. The difference between the consumer price and the product price is then split between the individual that sells the product, as well as distributor 123a and multi-level marketing company 122. Hence, distributor 123a and the corresponding individual that sells the product receives income in response to the sale of the product, and multi-level marketing company 122 receives income from the membership fee paid by distributor 123a, salespeople 124a and 124b, as well as the sale of the product. In this way, there is less risk for multi-level marketing company 122 to operate because company 122 receives some income (i.e. the membership fee) even if no products or services are sold.

In this embodiment, branch 129b includes levels 1, 2, 3 and 4, wherein distributor 123b is in level 1 and distributors 123c and 123d are in level 2. Hence, distributors 123c and 123d purchase product from distributor 123b. Branch 129b also includes distributors 123e, 123f and 123g in level 3, wherein distributors 123e, 123f and 123g purchase products and/or services from distributor 123d. Branch 129b further includes salespeople 124c, 124d and 124e in level 4, wherein salespeople 124c, 124d and 124e purchase products and/or services from distributor 123f.

In this embodiment, branch 129c includes level 1, which includes distributor 123h, wherein distributor 123h purchases products and/or services from multi-level marketing company 122. Distributor 123h can sell the products and/or services to the consumer, or distributor 123h can find another distributor or individual to purchase the product from him or her, as in branches 129a and 129b.

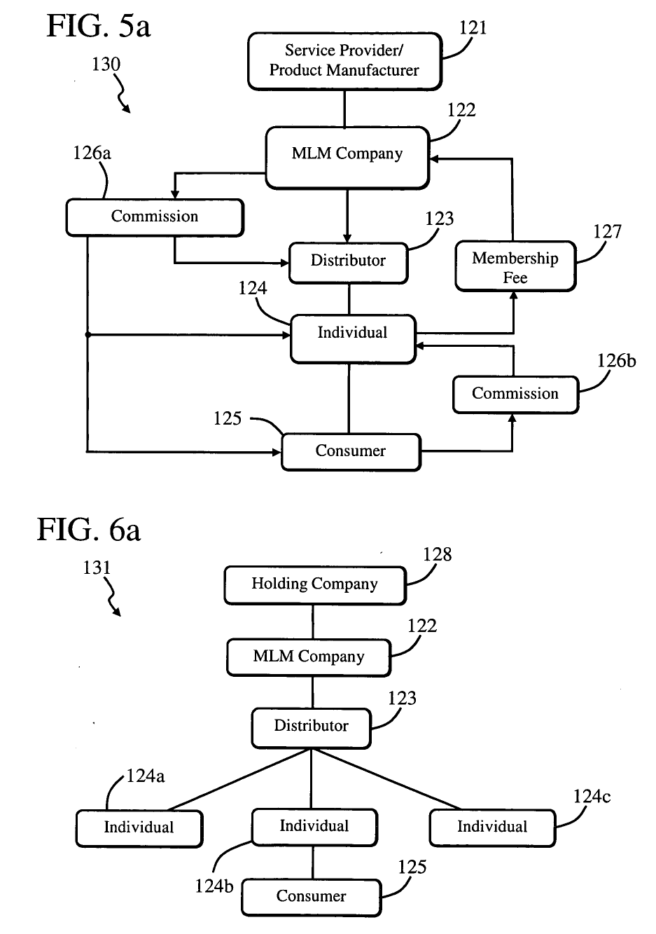

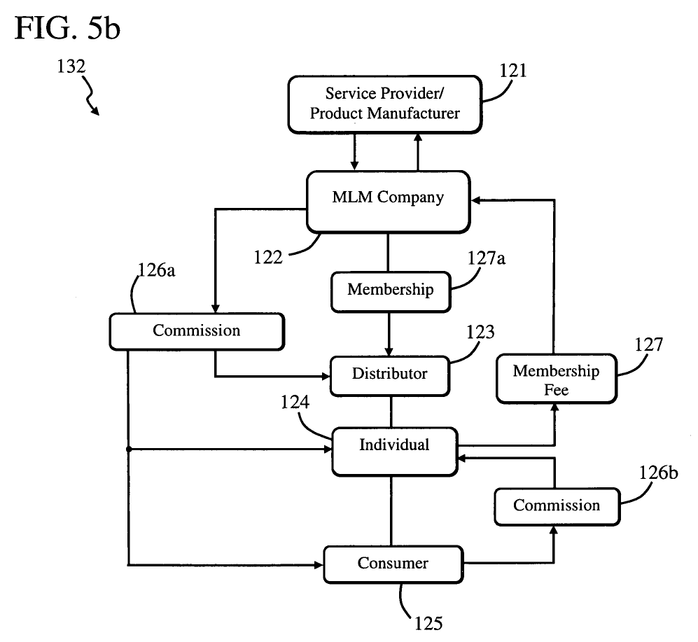

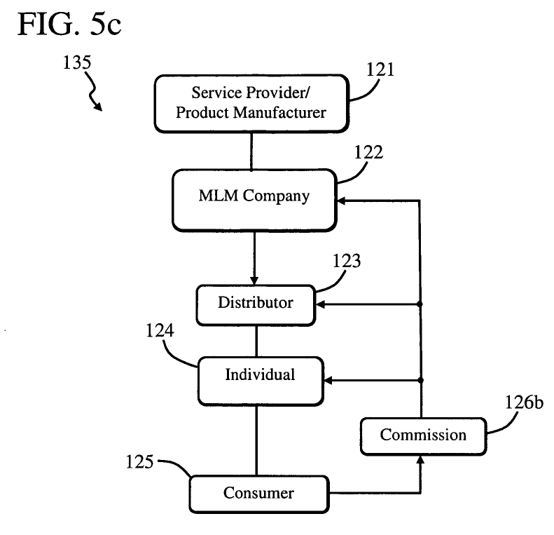

FIG. 5a is a flow diagram 130 of a commission structure, in accordance with the invention. It should be noted that the commission structure of flow diagram 130, as well as the other commission structures disclosed herein, can be implemented using the Internet or any other computer network. In this embodiment, service provider/product manufacturer 121 provides products and/or services to MLM company 122. MLM company 122 provides the products and/or services to distributor 123 at the member price, as described above. MLM company 122 can provide a commission 126a to distributor 123 in response to the product and/or services being distributed to individual 124.

Individual 124 is a member of MLM company 122 and, as a result, pays membership fee 127 thereto. Further, salespeople 124 sell the product and/or services to consumer 125. Individual 124 receives a commission 126a and/or 126b in response to selling the product and/or service to consumer 125. In some situations, MLM company 122 sells or supplies the product and/or services directly to individual 124 and/or consumer 125.

In one particular example, a product or service, denoted as “X” is purchased from supplier 121 by MLM company 122 for 1 unit, wherein one unit is typically a monetary unit (i.e. $10). MLM company 122 sells product or service “X” to individual 124 for 8 units (i.e. $80). The mark-ups used in this example are only for illustrative purposes, and it should be noted that other mark-ups can be used, which can be higher or lower than those discussed here. Individual 124 then adds a mark-up to the 8 unit price and sells product or service “X” to consumer 125. For example, the mark-up can be 20%, so that product or service “X” is sold to consumer 125 for 9.6 units. Individual 124 is thereby compensated for his or her efforts with commission 126b of 1.6 units. MLM company 122 then pays commission 126a to distributor 123, which can be a percentage of the multi-level marketing company's mark-up.

FIG. 5b is a flow diagram 132 of a commission structure, in accordance with the invention. Flow diagram 132 is similar to flow diagram 130 of FIG. 5a. In this embodiment, however, distributor 123 has a membership 127a to MLM company 122 so that distributor 123 can receive products and/or services from MLM company 122 at the member price. As mentioned above, individual 124 is a member of MLM company 122 and, as a result, pays membership fee 127 thereto.

In one example, product or service “X” is purchased from supplier 121 by MLM company 122 for 1 unit (i.e. $10). MLM company 122 sells product or service “X” to individual 124 for 1.9 units (i.e. $19), which is the member price. The member price may vary depending on the type of multi-level marketing company membership and the volume of business.

Individual 124 then adds a mark-up to the 1.9 unit member price and sells product or service “X” to consumer 125. The mark-up (i.e. commission 126b) added by individual 124 can be, for example, fifty percent (50%) so that product or service “X” is sold for 2.85 units (1.9 plus 0.5 times 1.9). Individual 124 receives commission 126b, which is, in this example, 0.95 units. MLM company 122 then pays to the various middle distributors, such as distributor 123 and/or individual 124, a percentage of the multi-level marketing company's mark-up as commission 126a.

In one example, consumer 125 selects a service contract from individual 124. The statistical model, discussed in more detail above, allows multi-level marketing company 122 to make a higher payment to individual 124 less frequently instead of smaller payments over a larger period of time. Hence, multi-level marketing company 122 can pay a one-time payment, denoted as commission 126a, up through distributor 123 of individual 124. In this way, distributor 123 and individual 124 receives a larger payment instead of a larger number of smaller payments.

FIG. 5c is a flow diagram 135 of a commission structure, in accordance with the invention. Flow diagram 135 is similar to flow diagrams 130 and 132 of FIGS. 5a and 5b, respectively. In this embodiment, service provider/product manufacturer 121 provides products and/or services to MLM company 122. MLM company 122 provides the products and/or services to distributor 123 at the member price, as described above.

Individual 124 is a member of MLM company 122 and, as a result, pays membership fee 127 thereto. Further, salespeople 124 sell the product and/or services to consumer 125. In this embodiment, consumer 125 pays commission 126b in response to buying the product and/or service from individual 124. Commission 126b can be paid by consumer 125 to individual 124, distributor 123 and/or MLM company 122. In this way, a consumer buys at least one of the product and/or service from an individual and, in response, at least one of the individual, distributor and multi-level marketing company receives a commission.

In one particular example, a product or service, denoted as “X” is purchased from supplier 121 by MLM company 122 for 1 unit, wherein one unit is typically a monetary unit (i.e. $10). MLM company 122 sells product or service “X” to individual 124 for 8 units (i.e. $80). The mark-ups used in this example are only for illustrative purposes, and it should be noted that other mark-ups can be used, which can be higher or lower than those discussed here. Individual 124 then adds a mark-up to the 8 unit price and sells product or service “X” to consumer 125. For example, the mark-up can be 20%, so that product or service “X” is sold to consumer 125 for 9.6 units. Individual 124, distributor 123 and/or MLM company 122 are thereby compensated for their efforts with commission 126b of 1.6 units.

In one embodiment of the invention, the use of the Internet by an individual to make a purchase directly with an online affiliate of the MLM company would generate a commission to the MLM company on the purchase. The MLM company provides a rebate from the commission to the individual, and a commission on the commission to the individual's upline. The use of the Internet by the MLM company in the purchase of banner ads encourages the MLM company's individuals to purchase a product and/or service at a less expensive cost as a result of the rebate.

The affiliate's stores may be accessible through the MLM company's own online store. Further, the holding company may include access to its own stores. The individual then shops at the MLM company's online store with the knowledge that, as an individual, they are able to acquire a product and/or service at a savings rather than going directly to that same store in person, or by accessing the same company's products via the same company's direct internet site. For example, Item A is purchased at Home Depot by an affiliate would cost the individual $X less $Y rebate, whereas a personal visit to a Home Depot store or via the direct home depot internet site, for example, to purchase the same Item A would cost the individual $X, and the upline from the individual would receive $Z of the rebate.

The balance of $X minus $Y is divided by the MLM company to the upline of the individual. The Individual is incentivized to shop at the stores or sites offering the largest rebates. The holding company may have its own stores or the stores of its parallel sister companies within the mall that can offer more lucrative rebates. In addition, a “widget”, for example, may sit on the counter desk of the individual, wherein the “widget” delivers music and/or videos to that individual at no cost, and that “widget” has a dedicated portal access into the MLM Company's online shopping mall. The individual can shop directly into the shopping mall creating the above rebates, wherein the individual can forward a link to a consumer to enable the consumer to shop in the MLM company's online shopping mall, and where the rebates are divided as described above from that consumers purchases.

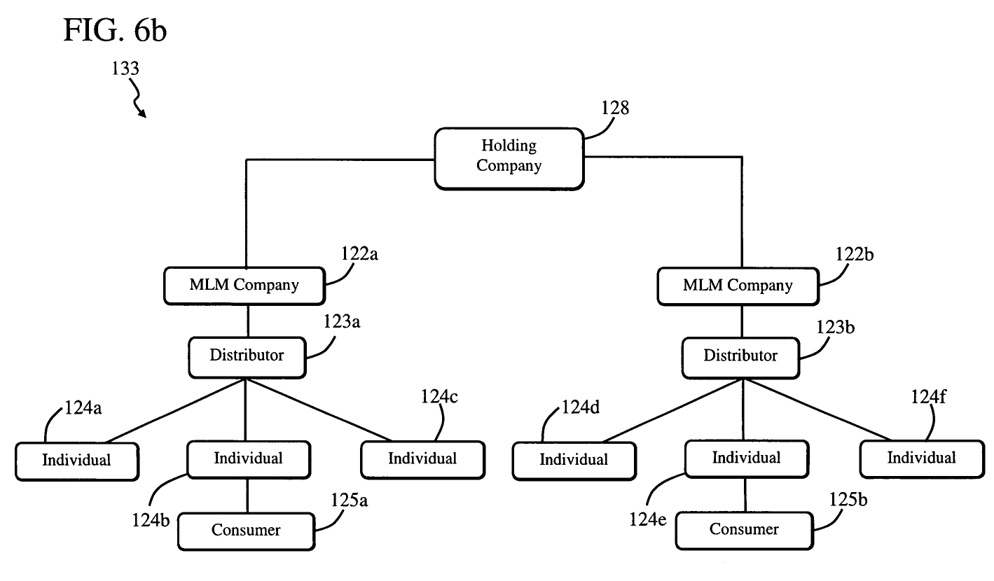

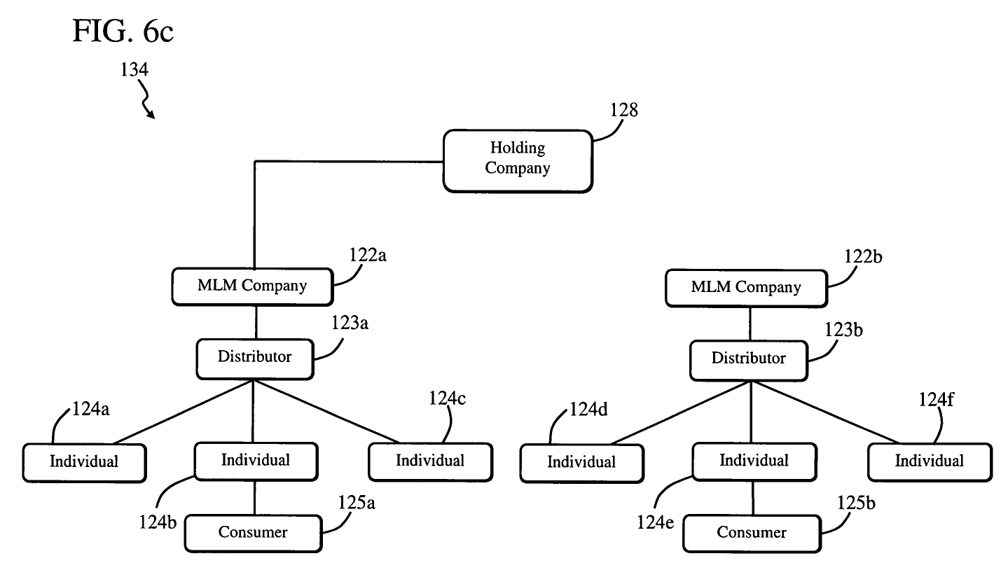

FIG. 6a is a block diagram of a multi-level marketing system 131, in accordance with the invention. In this embodiment, system 131 includes a holding company 128 which owns all of MLM company 122. MLM company 122 operates distributor 123 and salespeople 124a, 124b and 124c, who sell product and/or services to a consumer, such as consumer 125.

Distributor 123 to be spun off as a joint venture company with the multi-level marketing company upon reaching a critical number of representatives under them, by way of example, if the distributor achieves say 100,000 representatives under them, the distributor may be offered the option to form a joint venture company directly with the multi-level Holding Company that owns the multi-level marketing company, or the multi-level marketing company itself, by way of example this new company may be owned xx % by the multi-level holding company or the multi-level marketing company. In turn the new joint venture company between the multi-level marketing company or multi-level holding company and the distributor, that has been spun off may itself be in a position to offer itself to the public, as a publicly traded company by way of example it may offer to sell shares in itself in an, IPO, initial public offering, DPO, direct public offering, or any other security offering it may chose.

FIG. 6b is a block diagram of a multi-level marketing system 133, in accordance with the invention. In this embodiment, system 133 includes holding company 128 which owns and operates all of MLM companies 122a and 122b. MLM company 122a operates distributor 123a and salespeople 124a, 124b and 124c, who sell product and/or services to a consumer 125a, as discussed in more detail above. Further, MLM company 122b operates distributor 123b and salespeople 124d, 124e and 124f, who sell product and/or services to a consumer 125b, as discussed in more detail above.

Multi-level marketing system 133 is similar to multi-level marketing system 131 of FIG. 6a wherein system 133 includes more MLM companies operating in parallel. Systems 131 and 133 are useful because a number of MLM companies can operate in parallel so that multi-level marketing systems 131 and 133 can expand, if desired, to increase the flow of income. Systems 131 and 133 are also useful because a number of MLM companies can operate in parallel so that holding company 128 can increase the volume of products and/or services sold.

FIG. 6c is a block diagram of a multi-level marketing system 134, in accordance with the invention. In this embodiment, system 134 includes holding company 128 which owns and operates all of MLM company 122a. However, in this embodiment, holding company 128 does not own or operate MLM company 122b. MLM company 122a operates distributor 123a and salespeople 124a, 124b and 124c, who sell product and/or services to a consumer 125a, as discussed in more detail above. Further, MLM company 122b operates distributor 123b and salespeople 124d, 124e and 124f, who sell products and/or services to a consumer 125b, as discussed in more detail above.

Multi-level marketing system 134 is similar to multi-level marketing systems 131 and 133 of FIGS. 6a and 6b, respectively, wherein system 134 includes MLM companies 122a and 122b operating in parallel, but separately from each other. MLM companies 122a and 122b operate separately and independently from each other because MLM company 122a is owned and operated by holding company 128 and MLM company 122b is not owned and operated by holding company 128. Systems 131, 133 and 134 are useful because a number of MLM companies can operate in parallel so that multi-level marketing systems 131, 133 and 134 can expand, if desired, to increase the flow of income. Further, system 134 provides incentive to MLM company 122b to grow so that it can spin-off from, and operate independently of, holding company 128.

In conclusion, the system and method as described herein, improves the quality and volume of the business opportunities by changing the way a multi-level marketing company is structured. This new system and method in turn compensates a multi-level marketing company with a product mark-up combined with the membership fees. This new system and method also compensates the multi-level marketing company up-line from the sales generated by the salespeople and compensates the salespeople.

This results in an income opportunity that is substantially improved, because when a company can sell products and/or services for less, they typically earn more. The benefits of the system and method are far lower prices and higher profits from selling higher quality products. It is also much easier to recruit other salespeople into the multi-level marketing system. Further, with lower prices and overhead, a wider range of products and/or services can be provided to the consumer at a profit. With other systems, these products and/or services cannot be provided at a profit because the mark-up is too low.

While particular embodiments of the invention have been shown and described, numerous variations and alternate embodiments will occur to those skilled in the art. Accordingly, it is intended that the invention be limited only in terms of the appended claims.

1. A method of operating a multi-level marketing company, comprising:
providing an individual a membership to the company in response to the individual paying a membership fee to the company;
allowing the individual to purchase a product and/or service from the company at a member price; and
providing the product and/or service to a consumer at a consumer price, wherein the consumer price is greater than the member price.

2. The method of claim 1, wherein the step of allowing the individual to purchase the product and/or service at the member price occurs after the individual has paid the membership fee.

3. The method of claim 1, wherein the member price decreases as the membership fee increases.

4. The method of claim 1, wherein the step of providing a membership for the individual includes providing first and second membership levels.

5. The method of claim 4, wherein the membership fee for the first membership level is greater than the membership fee for the second membership level.

6. The method of claim 4, wherein the individual purchases the product and/or service at first and second member prices at the first and second membership levels, respectively, the first member price being less than the second member price.

7. A multi-level marketing system, comprising:
a manufacturer;
a multi-level marketing company which buys at least one of a product and/or service from the manufacturer; and
one or more individuals which buy at least one of the product and/or service from the multi-level marketing company.

8. The system of claim 7, wherein the individual(s) is a member of the multi-level marketing company.

9. The system of claim 8, wherein the individual(s) purchase the product and/or service at a member price after the individual has paid a membership fee to the multi-level marketing company, the membership of the multi-level marketing company having a plurality of membership levels.

10. The system of claim 9, wherein the membership fees for each membership level is different from the membership fee for another membership level.

11. The system of claim 9, wherein the member prices for each membership level is different from the member prices for another membership level.

12. The system of claim 9, wherein the member price decreases as the member price increases.

13. The system of claim 7, further including a consumer which buys at least one of the product and/or service from the individual and, in response, at least one of the individual, distributor and multi-level marketing company receives a commission.

14. A multi-level marketing system, comprising:
a holding company;
a first multi-level marketing company operated by the holding company, the first multi-level marketing company providing at least one of a product and/or service; and
one or more first individuals which buy at least one of the product and/or service from the first multi-level marketing company.

15. The system of claim 14, wherein the first individual(s) are members of the first multi-level marketing company.

16. The system of claim 14, wherein the first individual purchases the product or service at a member price from the distributor of the first multi-level marketing company.

17. The system of claim 14, wherein the membership of the first multi-level marketing company has a plurality of membership levels.

18. The system of claim 14, further including:
a second multi-level marketing company, the second multi-level marketing company providing at least one of the product and/or service;
at least one distributor which buys at least one of the product and/or service from the second multi-level marketing company; and
one or more second individuals which purchase at least one of the product and/or service from one of the distributors of the second multi-level marketing company.

19. The system of claim 18, wherein the second individuals are members of the second multi-level marketing company.

20. The system of claim 18, wherein the second individuals purchase a product or service at a member price from the distributor of the second multi-level marketing company.

21. The system of claim 18, wherein the second multi-level marketing company is not operated by the holding company.
